(19) United States
(12) Patent Application Publication
(10) Pub. No.: US 2021/0312299 A1
(43) Pub. Date: Oct. 7, 2021

(54) AI CONNECTOR MODULE

(71) Applicants: Justin Rafael Segal, Houston, TX (US); William Earl Daugherty, Houston, TX (US)

(72) Inventors: Justin Rafael Segal, Houston, TX (US); William Earl Daugherty, Houston, TX (US)

(73) Assignee: Stemmons Enterprise LLC, Houston, TX (US)

(21) Appl. No.: 16/842,747

(22) Filed: Apr. 7, 2020

(51) Int. Cl. G06N 5/02; G06N 20/00

(52) U.S. Cl. CPC G06N 5/02; G06N 20/00

(57) ABSTRACT

System and methods are disclosed to facilitate the active management and allocation of the knowledge resources of an organization. In one exemplary implementation, the systems and methods include an Artificial Intelligence (AI) controller module installed on a computing device, such as a computer server, configured to pass enterprise and transactional data to one or more AI systems, and accept the results back into the organization, either by changing data values or by creating cases or entities. The system collects data about the transaction and stores the data in a database for future use.

### CROSS-REFERENCE TO RELATED APPLICATIONS

Related subject matter may be found in the following commonly assigned, co-pending U.S. patent application, which is hereby incorporated by reference herein:

Ser. No. 16/577,922, entitled “System and Method for Implementing Enterprise Operations Management Trigger Event Handling”

### BACKGROUND OF DISCLOSURE

### Field of the Invention

The present invention relates generally to the field of artificial intelligence (AI) systems and methods thereof, and more particularly to techniques for using AI for managing and optimizing the knowledge resources of employees and organizations.

### Description of the Related Art

Enterprise operations environments are dynamic and complex. They typically involve multiple parties and require significant and timely communication and coordination. Numerous activities and decisions occur daily ranging from exception handling and management, resource configuration, as well as decisions based on collaboration and knowledge. In addition, the parties involved must adhere to numerous regulations and guidelines and be able to react in real-time.

Enterprise operations systems provide various methods for adding, changing, or otherwise improving information, either through human decision-making or via an automatic, software-based processes incorporated into the system. Adding value to information covers a wide range of activities, including creating new records, adding or changing numbers or text values in database fields, creating associations between data elements, task operations (such as initiating, escalating, resolving, assigning tasks), activating workflows, performing ranking or sorting functions, and countless other functions.

Many conventional systems are dependent on user action or built-in software-based processes to add value to information within the system, or to initiate activities to be carried out by a person or by operation of software.

Users increasingly seek to leverage AI systems that use various advanced computing techniques into their enterprise operations environments to add value to information or initiate actions. Examples of such systems include proprietary algorithms, neural networks, expert systems, natural language processing, speech and image recognition.

Users also seek to leverage AI systems that use advanced computer architectures and computing power to assist with adding value to information or initiating actions. Examples of such advanced computing architectures and power include server farms, massively parallel clusters of CPUs (central processing units), GPUs (graphical processing units), TPUs (tensor processing units), IPUs (intelligent processing units), quantum computing, massive on-demand object storage arrays, and other evolving systems.

Users also seek to leverage AI systems that use external data resources to assist with adding value to information or initiating actions. Such external data resources include proprietary information like social media streams, news feeds, pricing and product information, company and financial data, demographic and location-based data, and other subscription-based services, in addition to open-source and government-published datasets.

Regardless of the underlying subject matter or business process, leveraging these AI systems requires a series of generic steps, including collecting and preparing information, passing such information to the AI system, retrieving the results from the AI system, and taking appropriate steps to use such results either to improve information or initiate action of a person or software process. In addition, these generic steps often must be initiated on appropriate schedules.

Leveraging AI systems also requires elements that are very specific to the underlying subject matter or business process, such as determining what data elements to collect, how to prepare them, what AI system to use, and how to use the output of such AI models.

Users seeking to take advantage of such AI systems generally have two options: i) rely on dedicated-use (black box or hard-coded) products that use AI to perform a specific or limited function, or ii) invest in custom programming and integration using the complex toolkits required to connect to generic AI systems. The foregoing limitations must be overcome for enterprises to solve real-world problems with AI.

There is a need for systems and methods that automate and actively capture and manage an organization's knowledge and execute AI processes to make enterprise operation systems and methods less dependent on individual users to perform, manage and update all aspects of the methods and systems.

There is also a need for systems and methods to make AI resources accessible to enterprise systems in a modular and configurable manner that isolates all elements into a generic stylized container with pre-established structures.

There is a need for an approach that provides a common infrastructure for the generic portions of what an organization needs to do to leverage AI systems, and further to consolidate all non-generic portions into a single location data element with a standard syntax that is consumable by the generic portions of the system.

There is also a need for organizations to collect auditable information about how various AI systems are used throughout an organization and to have such information available for future use both for process-improvement and for legal or regulatory compliance purposes.

Stemmons Central AI Connector (CAIC) is an example of a universal connector that passes enterprise specific and transactional data to one or more third-party AI systems, and accepts the results back into the organization, either by changing data values, creating tasks or entities, or by initiating action by a person or software process. It will also handle feedback to help train machine learning models, and store information about the use of AI systems in an organization, all while logging the steps for auditing.

Non-human actors, such as a bot, feature, service, application, algorithm or RPA (robotic process automation) method, can receive and improve information pass it back into an organization's workflow. Organizations can access cloud-based AI services like IBM Watson, or similar offerings from Microsoft, Google and Amazon by passing information through to these AI services the organization can integrate algorithms, access data sources, tap into infrastructure and applications via API's and such.

A purpose of the present invention is to provide a system and method for AI instructions to be fed into an AI model which returns AI results.

Another purpose of the present invention is to provide a system and method for delivering a payload with a pre-defined format and syntax for processing AI Services.

Another purpose of the present invention is to provide a system and method for use with an AI connector of holding containers for cases or entities, activating them, for translating them into generic instructions, and for executing those instructions.

Another purpose of the invention is to provide a system and method for an AI model specific node to translate generic instructions into a specific syntax for the AI model.

A further purpose of the invention is a method to communicate with the AI model to send information.

A further purpose of the invention is to communicate with the AI model to receive the AI results.

A further purpose of the invention is to translate the AI results into one of several generic outcome formats.

### SUMMARY OF THE INVENTION

The embodiments of the present invention facilitate the active management and allocation of the knowledge resources of an organization in conjunction with using internal and external AI applications for a commercially available enterprise operations system such as Stemmons Central™. The embodiments of the present invention further provide a system and method for allowing actions for managing applications resources in an organization to be automatically triggered upon a specific event.

In a first exemplary embodiment, the system to facilitate the active management and allocation of the knowledge resources of an organization comprises an AI connector module (see FIGS. 1 & 2) 120 that can be installed on a computing device, such as a computer server. The AI connector module 120 can be configured to send and receive data according to AI models that will fire trigger events in real time to modify records of the organization or perform processes and specified actions. The system collects data about the transaction and stores the data in a database 124 for future use.

In a second exemplary embodiment, a computer-implemented generic method to facilitate the active management and allocation of the knowledge resources of an organization with AI is described. The exemplary method comprises an AI connector software module receiving data that will fire trigger events in real time to modify records of the organization or perform processes and specified actions. The system collects data about the transaction and stores the data in a database for future use.

In a third exemplary embodiment, a computer-readable storage medium comprising instructions to facilitate the active management and allocation of the knowledge resources of an organization is described. The instructions on the computer-readable storage medium can control the operation of an AI connector software module receiving data that will fire trigger events in real time to modify records of the organization or perform processes and specified actions. The instructions can direct the system to collect data about the transaction and store the data in a database for future use.

These and other embodiments are described in the detailed description that follows and the associated drawings.

### AI Connector for Enterprise Management System Framework

As mentioned, the embodiments of the present invention can be implemented with appropriate software modules configured with an enterprise operations system software, such as Stemmons Central™ enterprise operations software. Stemmons Central™ is a robust enterprise operations management system framework which may be used in conjunction with exemplary embodiments of the present invention, and reference is made to a more thorough discussion of the software in U.S. Pat. No. 10,558,505 to Segal et al., which is fully incorporated herein by reference.

Built on the Microsoft Stack on an open-source server-side web application ASP.NET using structured query language (SQL), Stemmons Central™ integrates with most third party applications, systems of record, legacy systems, and targeted applications, to bring disparate company data into one enterprise operations platform. In most cases, Stemmons Central™ uses application programming interfaces (APIs) to move information throughout a client's business enterprise. Information flow may be from person to person or to a non-human actor—a bot, feature, service, application, algorithm, Robotic Process Automation (RPA) method.

Integrations for the Stemmons Central™ platform presently take one of the following forms: Application provides metadata or information to Stemmons Central™, Application consumes metadata or information from Stemmons Central™, Application triggers functionality in Stemmons Central™ Core Applications; Application uses Stemmons Central™ for login functionality, security, and presentation layer; and Application receives commands from Stemmons Central™.

The Stemmons Central™ system consists of three different layers: Visualization, Functionality and Data Integration. The Visualization Layer acts as a unified presentation layer for the platform, third-party systems, and other applications. As a visualization layer, the platform handles: presentation of information from multiple systems; single sign-on; and interaction with various systems. The platform provides visualization in the following formats: HTML, SharePoint® and Mobile Applications. The Functionality Layer provides a set of core tools for common activities occurring throughout an organization. Stemmons Central's™ core applications presently include: Cases, Entities, Departments, Standards, and Quest. The Data Integration Layer integrates data from any existing system(s) into the system and creates a clearinghouse for enterprise data available to varied systems and users.

The benefits of the generic nature of the Stemmons Central's™ core tools/applications allow the platform to be deployed across a wide range of departments, processes, and activities. The system includes an interface to the system for the users, the interface being provided by the processor and permitting the users to view and modify the configurational hierarchies. Each user has access to one or more of the hierarchies, and each user can have different access permissions in different hierarchies.

Stemmons Central's™ core tools/applications for managing common activities occurring throughout an organization in conjunction with an AI connector module of the present invention will now be discussed in more detail.

### Cases

Cases is a universal task management, project tracker, and collaboration tool used to provide normalized information for people and systems. It includes creating tasks, projects, to-do lists, tickets, requests, status lists and other similar transactions of any size or duration. As with each of its core applications, Stemmons Central™ includes a configuration tool that allows users to set up and administer the Cases application, without the need for programming. Administrators and users can set up Case types, create constraints on information, determine security, and control how the information is displayed. An exemplary application architecture for Cases, as illustrated in FIGS. 1 and 2 for the present invention, includes multiple layers and components that work together to create a robust application. For integrating external applications or utilities, Cases uses the web service to communicate with a Data Access Layer, which in turn communicates with the database.

### Entities

Entities is a Stemmons Central™ tool that manages lists of things (physical or conceptual) and makes those lists available to people and systems within an enterprise. Entities can be physical items (such as equipment, buildings, or computers), non-physical things (like customers, vendors, or divisions) or concepts (categories, stages, project types). For example, a “List of Properties” for a real estate management company may be managed in Entities via a “Properties Entity Type” with option to assign people to the Entity via a “Role.” Building on that basic concept, Entities also allows for relationships between those things, and so, it can be thought of as a relational database that does not require programming. In addition, Entities provides a common set of tools that apply to any item tracked though the system, such as the ability to add images and documents, to associate people, or to provide an auditable change log. Entities can connect to other Stemmons Central™ systems, allowing the items it tracks to participate in various business processes.

The application architecture for Entities, similar to Cases, as it includes multiple layers and components that work together to create a robust application. Entities works well with other Stemmons systems without the need for integration or programming, but its architecture is also designed to easily integrate with other systems through an API. For integrating external applications or utilities, use the Common API (a different instance of the same dynamic link library file (DLL) that talks directly to a Data Access Layer to communicate with the Entities web service, or, if indicated, to use the web service directly.) The Common API also translates the Data Types between the Web Service to the API's Common Data Types by performing a deep copy of the objects

In an exemplary embodiment of the present invention, Entities may form the taxonomy of tracking various AI models as further illustrated in FIGS. 1 and 3: AI Provider 140, AI Service 302, AI Model 304 and AI Rule 142. Under the exemplary embodiment, AI Instructions 144 are fed to an AI Model 304, which returns AI Results 146. AI Providers 140 are for example, Google, Stemmons Enterprise, IBM Watson, Microsoft Azure and Amazon Web Services. Examples of AI Services 302 include four services provided by IBM Watson: Discovery, Discovery News, Machine Learning and Visual Recognition. Creating AI Models 304 is a higher-level activity. Examples of AI Models 304 that have been built by Stemmons Enterprise using the Discovery News Service are “Trending Topics” and “Customer News” as shown in FIG. 3.

### AI Rules Entities

A user may create any AI Rules entities 142 based upon an AI Model 304. For example, an AI Rule (e.g. AI Rule 1) named “Customer News of ALL Properties” might be created. The purpose of such an AI Rule 1 may be to provide news on the 10 largest customers per region by square footage to individuals in certain roles within an entity association in departments within that region. The Rule Code is written by a user to return this information. The Rule Code includes all relevant information required for the other generic elements to be successfully executed. To accomplish this, the Trigger Pipeline Assembly 202 as shown in FIG. 2, for instance WatsonDiscoveryNews.dll, is monitored. The system will then trackback to open Cases associated with the AI Rule.

### AI CAST Jobs

As illustrated in FIGS. 1 and 4B, an AI Cast Job 148 may run for an AI Rule 142 where the run Frequency may be hourly, daily, weekly, or at some other predetermined frequency. The Cast Job software module 148 selects all AI Rules 142, where the run Frequency parameter is set by a user. The Cast Job module 148 is agnostic to what AI Model 304, AI Service 140 or AI Rule 142 the system uses, and just responds to the run Frequency selected by the user. For each such AI Rule 142 with the appropriate Frequency, an AI Cast Job 148 creates a single “Create AI Instructions Case.” 150 (202a) and FIGS. 4A and 4C. In each such case, a “Create AI Instructions Case”150 (202a) will fire an OnCreate Trigger 130, execute that Trigger's instructions, and then the case will automatically close.

For example, the following cases may be created by a Cast Job 148: “Create AI Instructions for Largest 10. Customers News by Region” and “Create AI Instructions for Customer News to Property Managers.” 150 (202a) They each have a trigger 130 that fires On Create, generates AI Instructions entities 144, and then closes the case. For the most part, these cases do not require any human interaction and would be hidden from most users of the system. They are a place for the trigger to do its task, and an important part of the audit/debugging trail.

In the present invention, an AI Case type associated with AI operations (e.g. Create AI Instructions 150) is created automatically by a CAST Job 148 and closed automatically by a Trigger (e.g. 130). This hierarchy helps break-out work into multiple streams and log a step in the system's process. Most users will not interact with an AI Case Type except for audit/troubleshooting purposes.

In the same example, a “News Delivery” AI Case type is created after an OnCreate trigger (Create AI Results Entities) 134 fires in the News Results Entity Type 146. Another trigger (Handle Trigger) 136 passes the News Results to the Stemmons API 152, along with information needed to determine what kind of case type to create and which user would get them.

A “News Feedback” AI Case type is created when the user clicks a button next to a News Result to indicate whether it is relevant or not relevant which may fire an OnCreate trigger (Process Feedback) 138. Then these cases will be sent back to the AI Model for ongoing training.

### AI Instruction Entities

These entities are created by an OnCreate trigger 130 fired in the case prior to this step, Each AI Instruction 144 represents a discrete instruction to the AI Model 304, and includes everything the AI Connector module 120 and AI Model 304 need to generate the AI Results 146 and also formatting and instructions needed to format the results, complete the process, and prepare content for feedback.

The AI Connector module 120 can use the metadata in an AI Rule 142 to access information, including getting to the AI Model 304 and login credentials.

### News Delivery Cases

These cases, as illustrated in FIG. 4E, are created by a Trigger (e.g. 136) in the AI Results cases 146 (FIG. 4D). The represent one possible “last step” in the exemplary process. Additional options include, without limitation, creating other types of cases or tasks, creating or updating Entities, populating RSS feeds, changing data, or activating APIs. The AI Results 146 can be deserialized and formatted for human consumable content.

### AI Feedback Cases

These cases are created by clicking a feedback button in a feed or case that contains content from an AI Model 304. The buttons create the case and also pass it to context-driven info such as a link to the content and also to the AI Rule 142. A trigger (e.g. 138) fires OnCreate to send the feedback to the AI Model 304 for training.

The foregoing general discussion is not intended to be an exhaustive discussion of the Stemmons Central™ system related to the AI controller module, but merely to orient the reader to the benefits of the present invention used in conjunction with similar software. Further information about Stemmons Central™ can be found in appropriate programming manuals, user guides, websites, and similar publications.

### Summary of the Solution

Enterprise operations systems' core tools/applications, such as Stemmons Central's™ Entities and Cases applications, in addition to being programmed and controlled by users, can be configured to consume triggers that can “kickoff” a workflow to actively and automatically perform certain action on a specific event including in conjunction with an AI connector module. The AI connector module 120 will pass the data object via the web to and AI Provider 140 where the web service has the ability to handle certain process or workflow.

### BRIEF DESCRIPTION OF THE FIGURES

The preferred embodiments of the present invention are illustrated by way of example and are not limited to the following figures:

FIG. 1 illustrates an exemplary architecture for the components to facilitate an AI connector module in accordance with an exemplary embodiment of the present invention.

FIG. 2 illustrates another exemplary architecture for the components to facilitate an AI connector module in accordance with an exemplary embodiment of the present invention.

FIG. 3 illustrates exemplary screen displays showing certain features of the AI Provider, AI Service and AI Model entities in accordance with exemplary embodiments of the present invention.

FIG. 4A illustrates an exemplary screen displays showing certain features of the Create AI Instruction case in accordance with exemplary embodiments of the present invention.

FIG. 4B illustrates an exemplary screen displays showing certain features of the CAST Job function in accordance with exemplary embodiments of the present invention.

FIG. 4C illustrates an exemplary screen displays showing certain features of the Create AI Instruction Case List in accordance with exemplary embodiments of the present invention.

FIG. 4D illustrates an exemplary screen displays showing certain features of the AI Results case in accordance with exemplary embodiments of the present invention.

FIG. 4E illustrates an exemplary screen displays showing certain features of the News Delivery Case List in accordance with exemplary embodiments of the present invention.

FIG. 5 illustrates a method of an exemplary process capable of being performed by the present invention of setting a trigger to create AI Instruction Entities.

FIG. 6 illustrates a method of an exemplary process capable of being performed by the present invention of setting a trigger to push AI Instruction Entities to an AI connector module.

FIG. 7 illustrates a method of an exemplary process capable of being performed by the present invention of setting a trigger to process AI Results.

FIG. 8 illustrates a method of an exemplary process capable of being performed by the present invention of setting a trigger to process Feedback to train future results from the AI Connector module.

FIG. 9 illustrates a method of an exemplary process capable of being performed by the present invention of setting a trigger to create AiResultEntities from the output of the AI Connector module.

### DETAILED DESCRIPTION OF THE EXEMPLARY EMBODIMENTS

Although the exemplary embodiments will be generally described in the context of software modules running in a distributed computing environment, those skilled in the art will recognize that the present invention also can be implemented in conjunction with other program modules in a variety of other types of distributed or stand-alone computing environments. For example, in different distributed computing environments, program modules may be physically located in different local and remote memory storage devices. Execution of the program modules may occur locally in a stand-alone manner or remotely in a client/server manner. Examples of distributed computing environments include local area networks of an office, enterprise-wide computer networks, and the global Internet.

The detailed description that follows is represented largely in terms of processes and symbolic representations of operations in a computing environment by conventional computer components, which can include database servers, application servers, mail servers, routers, security devices, firewalls, clients, workstations, memory storage devices, display devices and input devices. Each of these conventional distributed computing components is accessible via a communications network, such as a wide area network or local area network.

The invention comprises computer programs that embody the functions described herein and that are illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an exemplary embodiment based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning to the figures, in which like numerals indicate like elements throughout the figures, exemplary embodiments of the invention are described in detail.

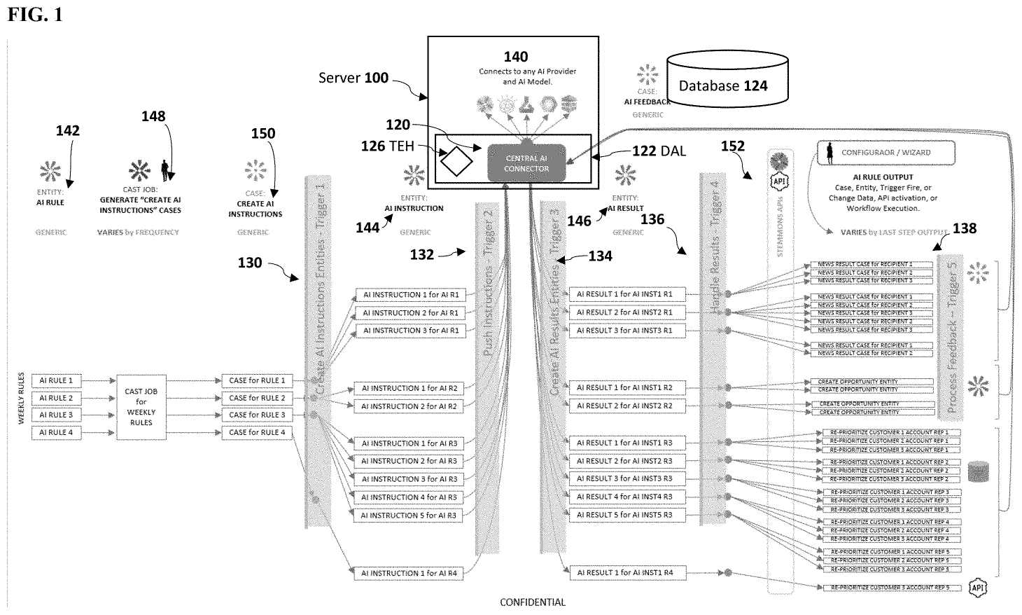

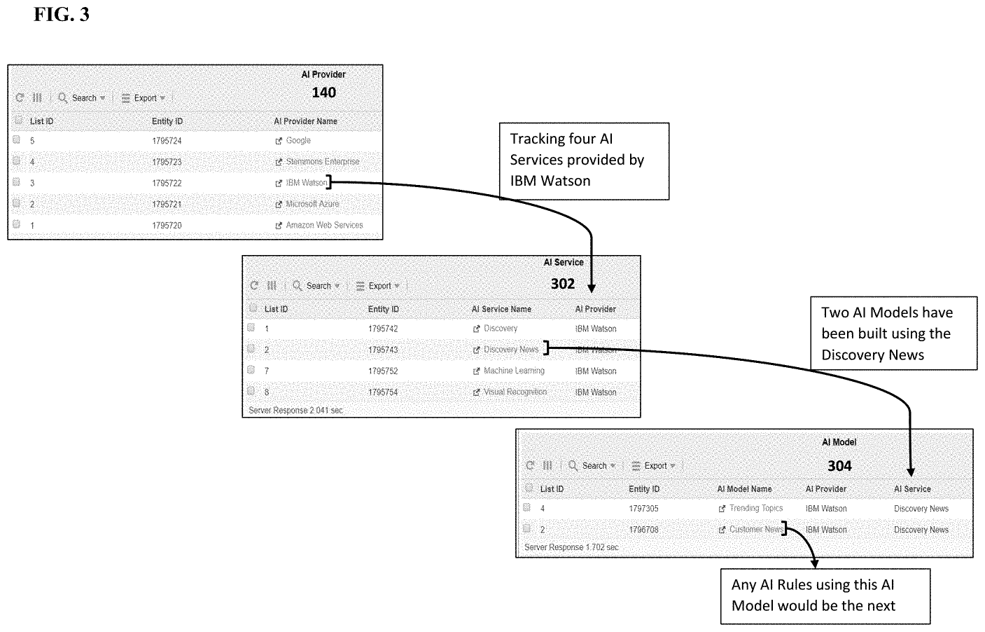

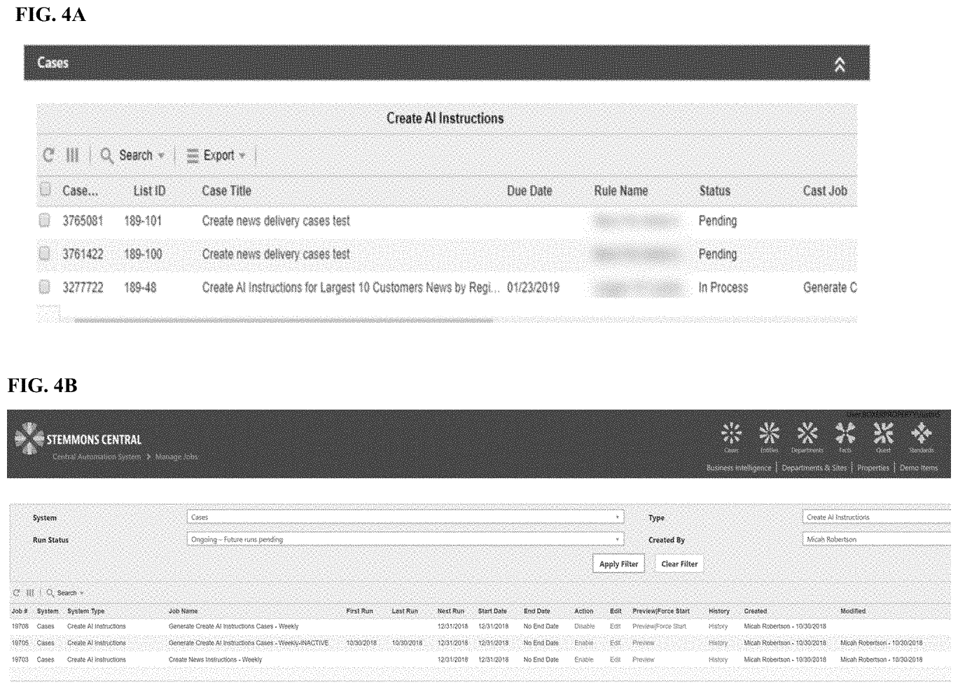

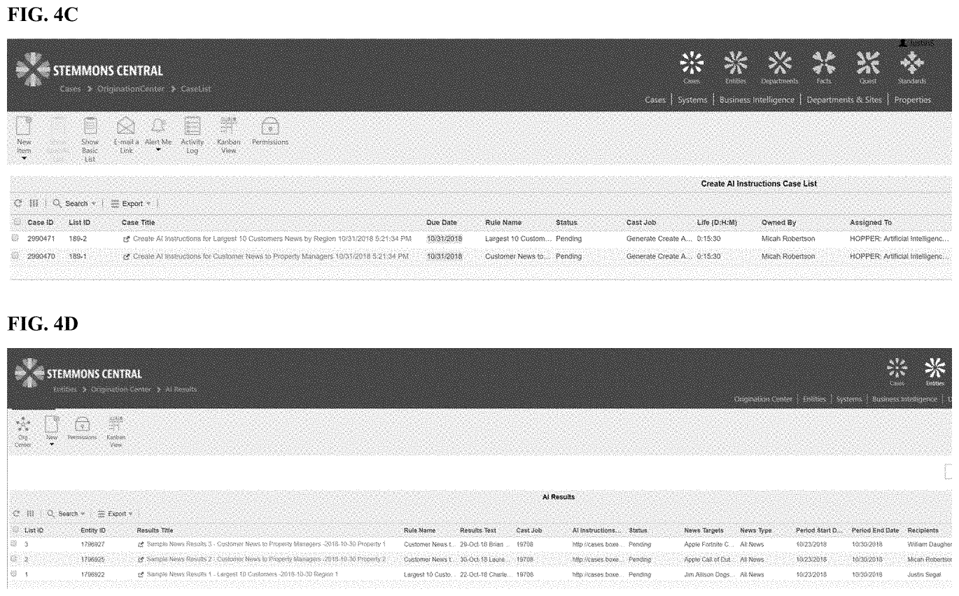

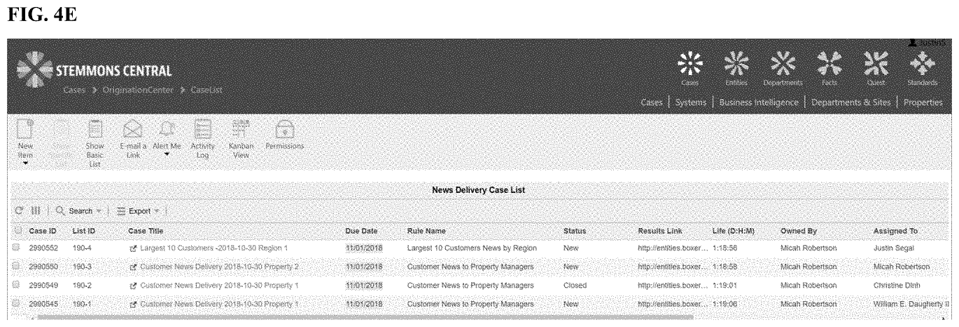

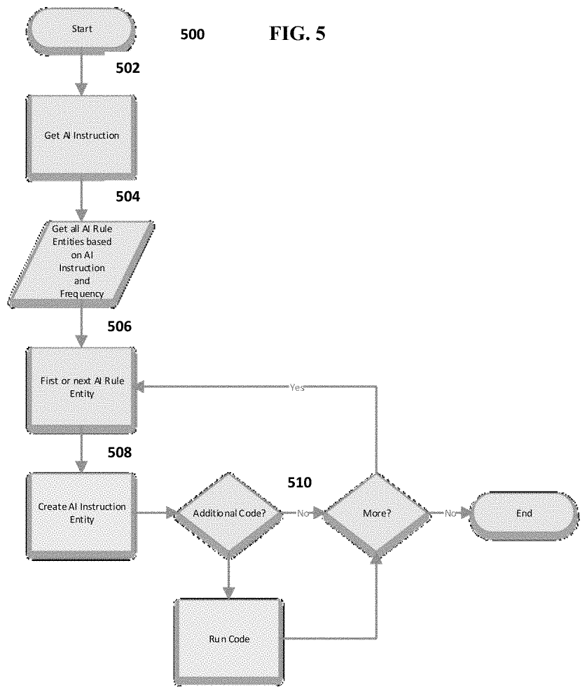

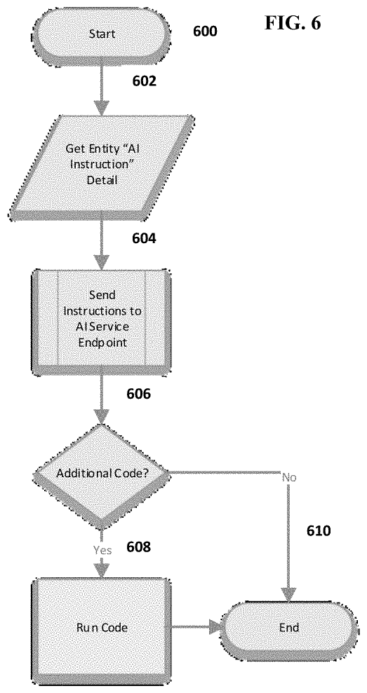

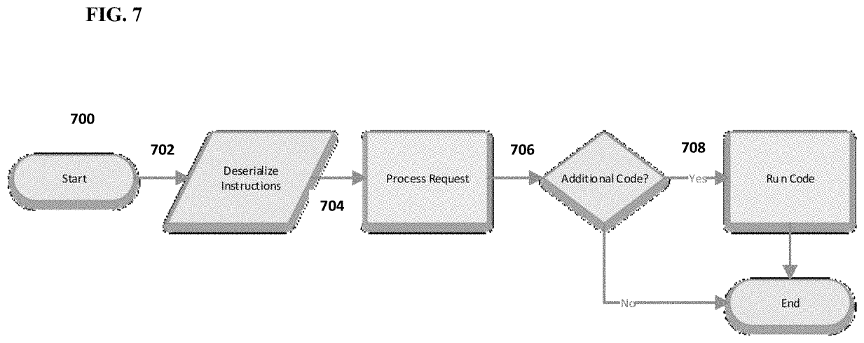

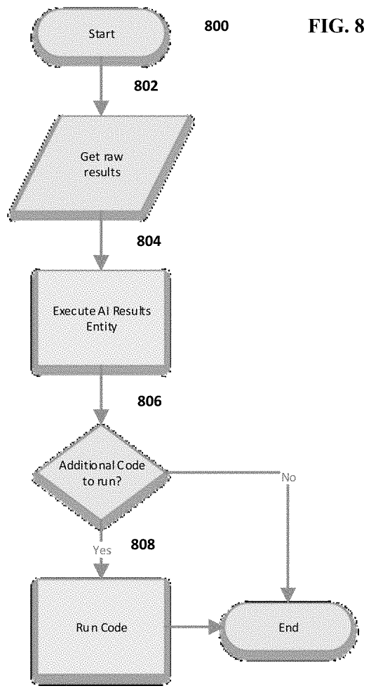

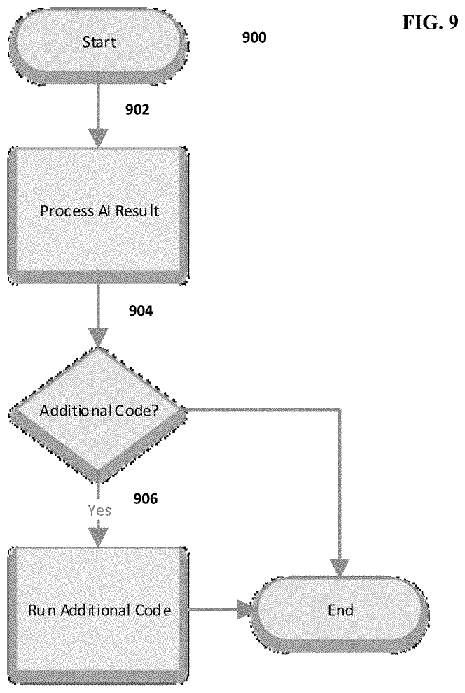

Referring to FIG. 1, aspects of an exemplary computing environment for an AI connector module is illustrated in which a system for actively managing the knowledge of an organization operates. Those skilled in the art will appreciate that the FIGS. 1-9 and the associated discussion are intended to provide a brief, general description of the preferred computer hardware and software program modules, and that additional information is readily available in the appropriate programming manuals, user guides, and similar publications.

FIG. 1 illustrates an exemplary AI connector module 120 installed on a server 100. The server 100 may be part of a web server, such as an Internet Information Services (IIS) for Windows® server for hosting on the internet. The AI connector module 120 is part of the data access layer (DAL) 122 of the server 100. Server 100 also comprises a user interface (UI) visualization layer, and a data layer or database(s). The visualization layer can comprise various software modules (such as a mobile service, ASP.Net web parts, or a web portal) used to communicate with and display information on for example user computers or mobile devices. The DAL 122 further comprises software modules used to retrieve data from and store data in the database 124. The software modules of the DAL 122 also can provide data to and receive data from a trigger event handler module 126 and a web server. In the exemplary embodiment shown in FIG. 1, the server 120 may also comprise a common API module, which can be bundled with any ancillary executable application. The exemplary AI connector module 120 has an API generally meant to be used by the AI connector module's system, but can be also used by other systems in the same way to connect to the AI systems directly to kick off requests, or to provide feedback into that AI system. The server may also comprise a Windows event timer, and a RESTful web service module.

The exemplary system illustrated in FIG. 1 may also comprises a configuration only web portal to facilitate access through a configurator's computer. Those of ordinary skill in the art will recognize that these modules and tools can be implemented in a variety of different software module configurations and a variety of computer environments such as those described in U.S. Pat. No. 10,558,505 to Segal et al.

The exemplary web server may have modules installed for applications including universal resource identifiers (URIs) for various triggers 1 through N. For example, in the exemplary embodiment in FIG. 1, there are five triggers: Trigger 1: Create AI Instructions Entities 130, Trigger 2: Push Instructions 132, Trigger 3: Create AI Results Entities 134, Trigger 4: Handle Results 136, and Trigger 5: Process Feedback 138. The preferred exemplary workflows for these triggers are described below and in FIGS. 5-9.

As shown in the exemplary system illustrated in FIG. 1, the AI connector module 126 can access one or more triggers (130, 132, 134, 136, 138) through the data access layer 122. The AI connector module 120 comprises software modules that can receive and analyze real time data to determine whether a trigger event (Push Instructions) 138 has occurred. An administrator or other user can use a computer through a configuration web portal to set triggers in the database 124.

FIG. 1 includes conventional computing devices suitable for supporting the operation of the preferred embodiments of the present invention. The computing devices may operate in a networked environment with logical connections to one or more remote computers. The logical connections between computing devices may be represented by a local area network and a wide area network. Those of ordinary skill in the art will recognize that in this client/server configuration, the remote computer may function as a file server or computer server. Those of ordinary skill in the art also will recognize that the invention can function in a stand-alone computing environment.

The computing devices represented in FIG. 1 include one or more processing units, such as microprocessors manufactured by Intel Corporation of Santa Clara, Calif. or AMD. The computing devices also include system memory, including read only memory (ROM) and random-access memory (RAM), which are connected to the processing units. Those skilled in the art will also appreciate that the present invention may be implemented on computers having other architectures, operating systems, and those that utilize other microprocessors. Users may enter commands and information into the computing devices by using input devices, such as keyboards and/or pointing devices, such as a mouse. One or more monitors or other kind of display devices is connected to the computing devices. Although other internal components of the computing devices and servers are not shown in the Figures, those of ordinary skill in the art will appreciate that such components and the interconnection between them are well known. Accordingly, additional details concerning the internal construction of the computing devices need not be disclosed in connection with the present invention.

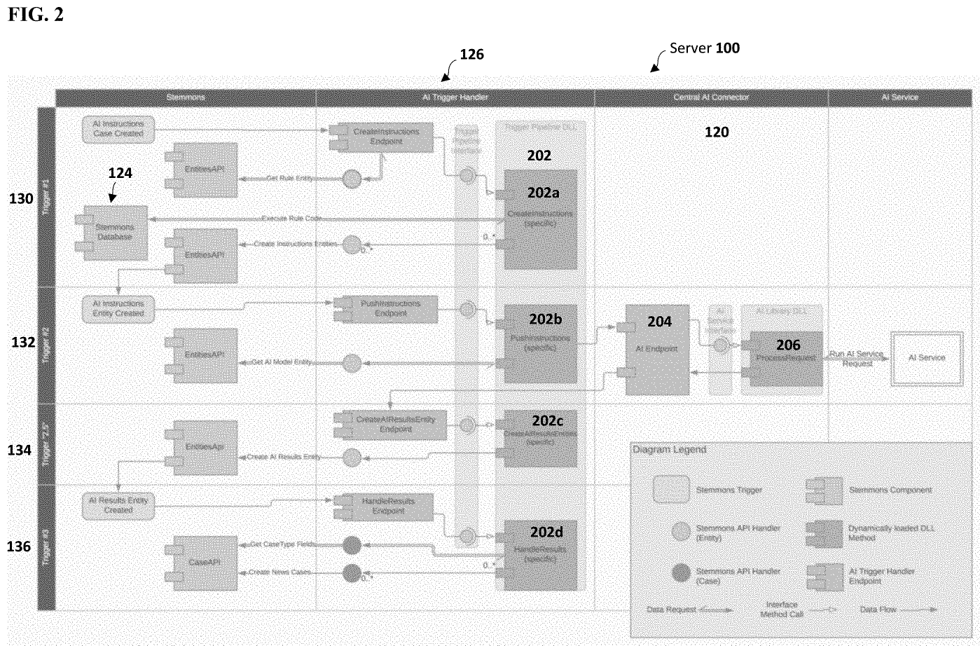

Referring to FIG. 2, an exemplary system and method for automating and actively managing an enterprise's knowledge and executing AI processes is illustrated. Those of skill in the art will recognize that exemplary method and the following discussion are merely one embodiment of the invention. In alternate embodiments of the invention, certain steps of the method may be performed in a different sequence, performed in parallel, or eliminated altogether. Furthermore, in alternate embodiments of the invention other software modules operating on local or remote computing devices may perform the steps of exemplary method

Turning now to step 202, the system is used to create ‘AI Instructions” entities 144 to be sent to the AI connector module 120 for processing. AI Instructions are created and sent when a ‘Create AI Instructions’ case 150 with a referenced ‘AI Rule’ 142 is created (automatically via CAST 148 or manually). A configurator's computer (not shown) is used to configure one or more triggers (130, 132, 134, 136, 138), including the locations (URI) to call, which is stored on the database 124. The person configuring the system will build a configuration table called “TriggerEvent” with the following columns:

TriggerEventID <system>TypeID (e.g., CaseTypeID, EntityTypeID,
etc . . .)
OnEvent
WebAPIUrl
WebAPIMode (e.g., Push, Post, etc . . .)
CustomJSONString (e.g., Enough JSON to create a Case, or modify it,
etc . . .)
SendRawString (If ‘Y’ it will pass in the raw JSON source object such as
the case, or the entity, etc . . .)

When an “On-Event” happens in the respective system in FIGS. 1 and 2, the system will query the configuration database 124 to see if there is an event that it should perform. The database 124 can store data for access by various components of the exemplary system shown in FIGS. 1 and 2. In the exemplary process, the user computer, communicating through the web portal, is used to create a case, and data concerning the case is stored in the database 124. Simultaneously with the creation of a Case, the trigger event handler module 126 and the AI connector module 120 check for triggers for the Case in the DAL 122.

The public interface ItriggerPipeline may contain one or more of the representative code strings for triggers as further reflective of the workflow illustrated in FIGS. 5-9:

//The Configuration value of the HttpRequest, used for building the HttpResponseMessage
dynamic Configuration { get; set; }
//The unedited HttpRequest sent to the endpoint. Included for building the HttpResponseMessage
HttpRequestMessage HttpRequest { get; set; }
//The Parsed Content of the HttpRequest
dynamic Request { get; set; }
//Trigger 1: Creates AI Instruction Entities, given an AI Instructions Case
public Task<HttpResponseMessage> CreateInstructions(IAiInstructionsCase request = null)
Trigger 1 - Create
//Trigger 2: Push AI Instruction Entities to the Central AI Connector
Task<HttpResponseMessage> PushInstructions(IAiInstructionsEntity request = null)
//Trigger 3: Process AI Results
Task<HttpResponseMessage> HandleResults(IAiResultsEntity request = null)
//Trigger 4: Process Feedback to train future results from the Central AI Connector
Task<HttpResponseMessage> ProcessFeedback(dynamic request = null)
//Trigger 2.5: Creates AiResultEntities from the output of the Central AI Connector
Task<HttpResponseMessage> CreateAiResultsEntities(dynamic request = null)

Referring now to FIGS. 1 and 5, and the exemplary method 500 of a trigger (Trigger 1) 130 to create AI Instruction Entities 144. The system and a custom app are configured to get an AI Instruction in step 502 and then to get all AI Rule Entities 142 based upon that AI Instruction and Frequency in step 504. Beginning with the first and proceeding to the next AI Rule Entities 142, the system and custom app create an AI Instruction Case 150 in step 508. If there is additional code, the service will run that code, otherwise if there are more AI Rule Entities 142, the system will proceed again with Step 508 to create the next AI Instruction Entity 144. Once there are no more AI Instruction Entities to create and code to run the, create AI Instruction Entities 144 process will end.

Referring now to FIGS. 1, 2 and 6, and the exemplary method 600 of a trigger (Trigger 2) 132 to push AI Instruction Entities 144 to an AI connector module 120. The system and a custom app are configured to get AI Instruction Entities 144 in step 602 and then to send them in step 604 to an AI Service Endpoint 204 located in the AI connector module 120 and the process will end. The system and custom app will determine in step 606 if there is additional code, the service will run that code, otherwise the process will end. In the exemplary embodiment, the AI Instruction Entities 144 are sent to the AI connector module 120 and received as JSON objects. The AI connector module 120 executes the AI Instruction Entities 144 at the AI Service Endpoint 204 based on the particular AI Provider 140 and connects to the AI Provider 140 through an API and sends instructions in a serialized format required to facilitate the request for the AI Provider 140 to perform. Once the AI Provider 140 processes the AI Service Request, the AI connector module 120 receives a response back from the AI Provider 140 to the request sent. Afterwards, the response is sent back to the Create AI Result Entity trigger 134 and the Create AI Result Entity will deserialize the response before creating the AI Result entities 146.

Referring now to FIGS. 1, 2 and 7, and the exemplary method 700 of a trigger (Trigger 3) 134 to create AI Results entities. The system and a custom app are configured to get AI Results for AI Instructions 146 in step 702 and then to send them to be processed 206 in step 704. The system and custom app will determine in step 706 if there is additional code, the service will run that code, otherwise the process will end.

Referring now to FIGS. 1, 2 and 8, and the exemplary method 800 of a trigger (Trigger 5) 138 to process Feedback to train future results from the AI Connector module. The system and a custom app are configured to get raw AI Results for AI Instructions 146 in step 802 and then to execute an AI Results Entity in step 804. The system and custom app will determine in step 806 if there is additional code, the service will run that code 808, otherwise the process will end.

Referring now to FIGS. 1, 2 and 9, and the exemplary method 900 of a trigger 136 to process AI results from the AI Connector module 120. The system and a custom app are configured to get in step 902 AI Results for AI Instructions 146. The system and custom app will determine in step 904 if there is additional code, the service will run that code 906, otherwise the process will end. An internal trigger 136 processes responses from the ‘AI Results’ entities which contain the response from a web API. The system handles the contents of each ‘AI Results’ entity which was created by a trigger (each contains the response JSON of a web API operation). Typically, this entails creating ‘AI Results’ cases, but many things can be done with the response in this method (writing to a database, sending emails/SMS, etc.).

Alternate embodiments of the invention may perform variations of steps described above. However, the present invention improves and automates conventional enterprise operations software management approaches by incorporating AI. Furthermore, those skilled in the art will appreciate that systems and methods described above merely exemplary. For instance, in alternate embodiments of the invention, the software modules illustrated in FIGS. 1 and 2 that perform the steps of method can be consolidated into a single software module or can be split up into multiple sub-component software modules.

The foregoing components and instances of the present invention are merely examples. Other embodiments of the AI connector module 120 may include different features and may comprise different software modules organized in different designs. Furthermore, although the AI connector module 120 is shown installed on server 100, in alternate embodiments it may be installed in other computing environments.

The embodiments set forth herein are intended to be exemplary. From the description of the exemplary embodiments, equivalents of the elements shown herein and ways of constructing other embodiments of the invention will be apparent to ordinary practitioners of the art. While representative software modules are described as performing the methods of the invention, variations of these software modules can also be used to execute the invention. Many other modifications, features and embodiments of the invention will become evident to those of skill in the art. It should be appreciated, therefore, that many aspects of the invention were described above by way of example only and are not intended as required or essential elements of the invention unless explicitly stated otherwise, and that numerous changes can be made therein without departing from the spirit and scope of the invention.

What is claimed is:

1. An enterprise operations management computing system for managing and allocating knowledge resources comprising a memory coupled to an artificial intelligence connector module and a processor which is configured to execute programmed instructions stored in the memory comprising:
selecting one or more AI Rules entities, based upon run frequency, to create one or more AI Instructions cases;
executing one or more triggers to construct one or more AI Instructions entities based upon said AI Instructions cases;
executing one or more triggers to push one or more said AI Instructions entities to said artificial intelligence connector module;
wherein said artificial intelligence connector module connects through an interface to one or more AI Providers for processing one or more AI Service Requests based upon said one or more AI Instructions entities,
receiving results from said one or more AI Providers to said one or more AI Service Requests;
executing one or more triggers to construct one or more AI Results entities for said one or more AI Instructions entities based upon results received from said one or more AI Providers to said one or more AI Service Requests; and
executing one or more triggers to handle said one or more AI Result entities.

2. The system of claim 1, further comprising the further step of executing one or more triggers to create one or more AI Feedback cases.

3. A non-transitory computer readable medium having stored thereon instructions for managing and allocating knowledge resources comprising machine executable code which when executed by at least one processor, causes the processor to perform steps comprising:
selecting one or more AI Rules entities, based upon run frequency, to create one or more AI Instructions cases;
executing one or more triggers to construct one or more AI Instructions entities based upon said AI Instructions cases;
executing one or more triggers to push one or more said AI Instructions entities to said artificial intelligence connector module;
wherein said artificial intelligence connector module connects through an interface to one or more AI Providers for processing one or more AI Service Requests based upon said one or more AI Instructions entities,
receiving results from said one or more AI Providers to said one or more AI Service Requests;
executing one or more triggers to construct one or more AI Results entities for said one or more AI Instructions entities based upon results received from said one or more AI Providers to said one or more AI Service Requests; and
executing one or more triggers to handle said one or more AI Result entities.

4. The medium of claim 3, further comprising the further step of executing one or more triggers to create one or more AI Feedback cases.

5. A method for managing and allocating knowledge resources, the method comprising:
selecting one or more AI Rules entities, based upon run frequency, to create one or more AI Instructions cases;
executing one or more triggers to construct one or more AI Instructions entities based upon said AI Instructions cases;
executing one or more triggers to push one or more said AI Instructions entities to said artificial intelligence connector module;
wherein said artificial intelligence connector module connects through an interface to one or more AI Providers for processing one or more AI Service Requests based upon said one or more AI Instructions entities,
receiving results from said one or more AI Providers to said one or more AI Service Requests;
executing one or more triggers to construct one or more AI Results entities for said one or more AI Instructions entities based upon results received from said one or more AI Providers to said one or more AI Service Requests; and
executing one or more triggers to handle said one or more AI Result entities.

6. The method of claim 5, further comprising the further step of executing one or more triggers to create one or more AI Feedback cases.
